(19) United States
(12) Patent Application Publication
(10) Pub. No.: US 2009/0034254 A1
(43) Pub. Date: Feb. 5, 2009

(54) LED LAMP

(76) Inventor: Tang-Yueh HUNG, Taichung Hsien (TW)

Correspondence Address: SINORICA, LLC, 528 FALLSGROVE DRIVE, ROCKVILLE, MD, 20850, US

(21) Appl. No.: 11/830,033

(22) Filed: Jul. 30, 2007

(51) Int. Cl. F21V 21/005

(52) U.S. Cl. 362/249

(57) ABSTRACT

An LED lamp includes a housing, at least one circuit board, several LED and two conductive plates. The LED are mounted under a bottom face of the circuit board. The circuit board and the LED are all installed in the housing with the LED located at a bottom end of the housing. Two through holes are formed on a top end of the housing. The conductive plates are mounted in the housing. The bottom ends of the conductive plates are electrically connected with the circuit board. The top end of each conductive plate has at least one insertion hole in alignment with the through hole of the housing. The LED lamp is inbuilt with LED so that it is unnecessary to further install any LED bulb. Two electric wires can be respectively fitted through the through holes and inserted into the insertion holes of the conductive plates. Therefore, multiple LED lamps can be easily connected by connecting the electric wires.

### BACKGROUND OF THE INVENTION

The present invention is related to a lamp, and more particularly to an LED lamp.

It is known that LED can emit light at low power consumption. Therefore, it is a trend to replace the traditional lamp with LED. In general, LED is manufactured to have a form of bulb. Under such circumstance, in use, LED must be seated in a bulb socket. This is inconvenient.

Furthermore, the conventional LED lamp can not be serially connected or parallelly connected. Therefore, the brightness of the LED lamp is fixed and unadjustable. In the case that higher brightness is needed, the illumination provided by the conventional LED equipment will be insufficient.

### SUMMARY OF THE INVENTION

It is therefore a primary object of the present invention to provide a lamp which is directly inbuilt with LED.

It is a further object of the present invention to provide the above LED lamps which can be connected with each other to increase the brightness.

The present invention can be best understood through the following description and accompanying drawings wherein:

### BRIEF DESCRIPTION OF THE DRAWINGS

FIG. 1 is a perspective assembled view of the LED lamp of the present invention;

FIG. 2 is a perspective exploded view of the LED lamp of the present invention;

FIG. 3 is a longitudinally sectional view according to FIG. 1;

FIG. 4 is an enlarged perspective view of a part of the LED lamp of the present invention, showing the conductive plates installed in the housing;

FIG. 5 is a sectional view according to FIG. 3, showing that two electric wires are inserted into the lamp;

FIG. 6 is a sectional view according to FIG. 4, showing that two electric wires are inserted into the lamp;

FIG. 7 shows a circuit diagram used in the invention; and

FIG. 8 shows another circuit diagram used in the invention.

### DETAILED DESCRIPTION OF THE PREFERRED EMBODIMENTS

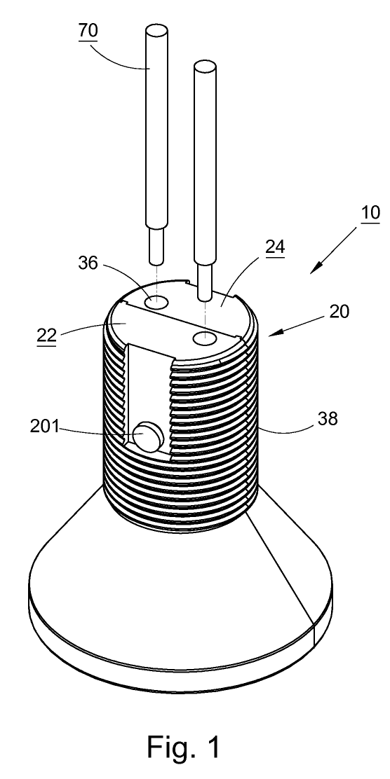

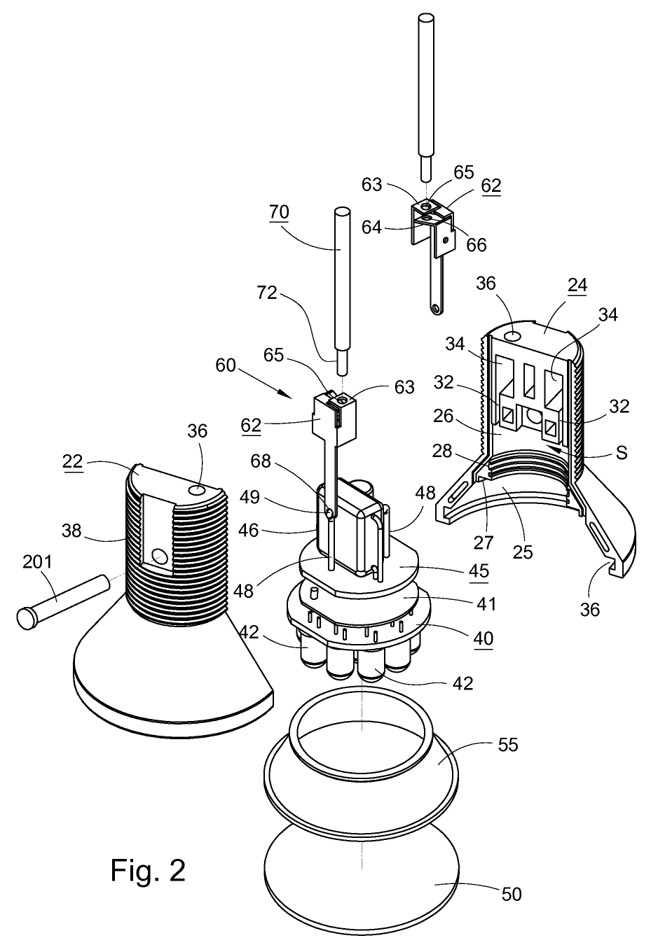

Please refer to FIGS. 1 and 2. According to a preferred embodiment of the present invention, the LED lamp 10 includes a housing 20 and LED, circuit boards and conductive plates installed in the housing 20.

The housing 20 is composed of two symmetric halves 22, 24 mated with each other. The two halves 22, 24 are locked with each other by means of a screw member or a rivet 201. A bottom end of the housing 20 is an open end. The housing is hollow and has an receiving space S. Two locating sections 27, 28 are formed on inner wall face of the housing 20 to define the receiving space S into a lower chamber 25 and an upper chamber 26. The lower chamber 25 is located at the bottom end of the housing, while the upper chamber 26 is closer to a top end of the housing. The two locating sections are grooved structures. The lower locating section 27 is near the lower chamber 25, while the upper locating section 28 is near the upper chamber 26. Two insertion slits 32 are vertically side by side formed in the housing. Bottom ends of the insertion slits 32 communicate with the upper chamber 26. Two small spaces 34 are formed in the housing above the two insertion slits 32 to respectively communicate with top ends of the two insertion slits 32. Two through holes 36 are formed on a top end of the housing 20. Bottom ends of the through holes 36 respectively communicate with the two small spaces 34.

In practice, each of the receiving space, the locating sections, the insertion slits, the chambers and the small spaces is divided into two halves respectively formed in the two halves of the housing.

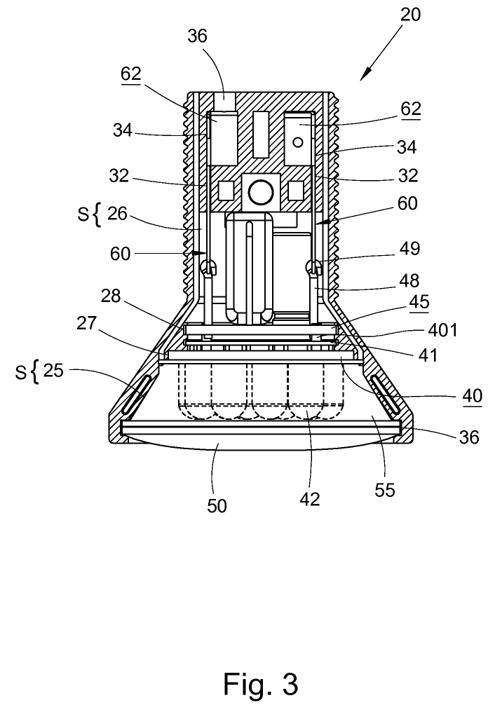

Two circuit boards 40, 45 are horizontally parallelly arranged and electrically connected with each other via connecting wires 401 as shown in FIG. 3. The two circuit boards are separated from each other by an insulating board 41. The two circuit boards are printed with circuits. Several LED 42 are soldered on a bottom face of the lower circuit board 40. Several electronic elements 46 are soldered on a top face of the upper circuit board 45. The circuit boards 40, 45 together with the LED 42 and the electronic elements 46 are installed in the receiving space S of the housing 20. The lower circuit board 40 is positioned in the lower locating section 27 as shown in FIG. 3, while the upper circuit board 45 is positioned in the upper locating section 28. The insulating board 41 is positioned in an annular groove between the locating sections 27, 28. The LED 42 are located in the lower chamber 25, while the electronic elements 46 are located in the upper chamber 26.

A lens 50 is inlaid in an annular groove 36 of the housing 20 to block the open bottom end of the housing 20. The light emitted from the LED can pass through the lens 35.

An optical collector 55 which is a hollow conic body is mounted in the lower chamber 25 of the housing 20 to concentrate the light.

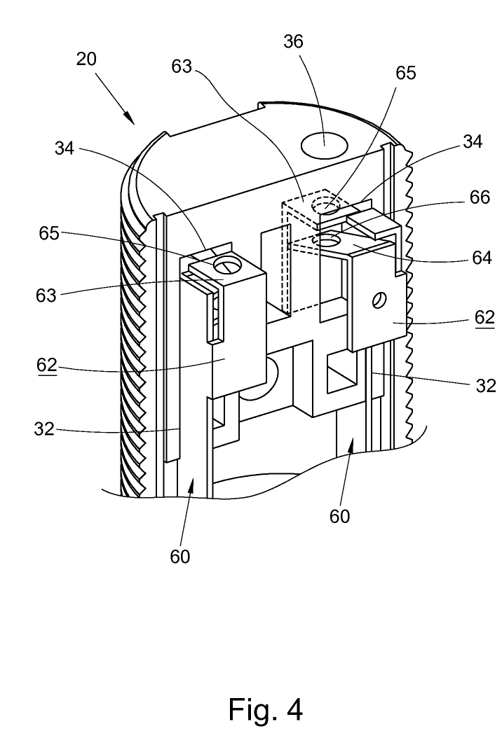

Two conductive plates 60 are mounted in the housing. A top end of each conductive plate 60 has an insertion section 62 formed with at least one insertion hole. To speak in more detail, the insertion section 62 is a rectangular structure having a top face 63 and an oblique plate 64 positioned under the top face 63. The oblique plate 64 is a cantilever and a free end of the oblique plate 64 is swingable. A first insertion hole 65 is formed on the top face 63 and a second insertion hole 66 is formed on the oblique plate 64. The first and second insertion holes 65, 66 are aligned with each other. The two conductive plates 60 are respectively installed in the two insertion slits 32 and located in the housing 20. As shown in FIGS. 3 and 4, Bottom ends of the conductive plates 60 are electrically connected with the upper circuit board 45 to serve as a positive electrode and a negative electrode. The two insertion sections 62 are respectively positioned in the two small spaces 34. The insertion holes 65, 66 of each insertion section 62 are aligned with a through hole 36 of the housing. In this embodiment, two contact pins 48 are arranged on the top face of the upper circuit board 45. Each contact pin has a top end formed with a hook section 49 hooked in a hole 68 of bottom end of the conductive plate 60 for conducting current as shown in FIGS. 2 and 3.

The above components are assembled to form a lamp with LED. The conductive plates 60 can be connected to a power source to light up the LED 42. An outer circumference of the housing 20 is formed with a thread 38. Accordingly, the LED lamp can be screwed and fixed in a certain position. Alternatively, an iron plate can be fixed on the outer circumference of the housing. By means of the iron plate, the LED lamp can be fixed in a certain position.

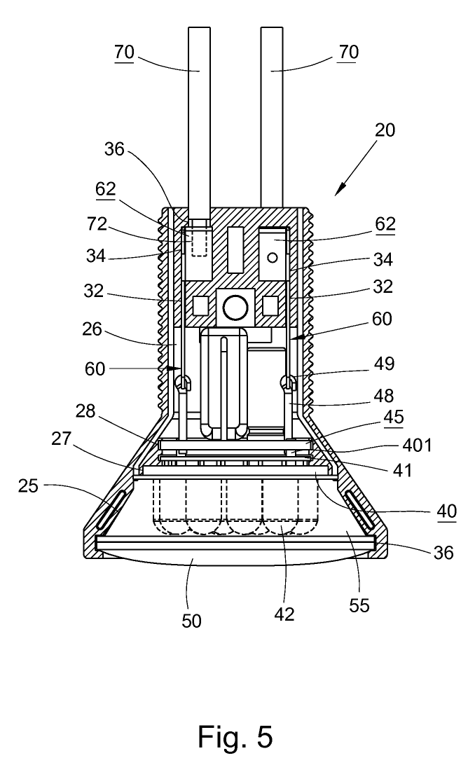

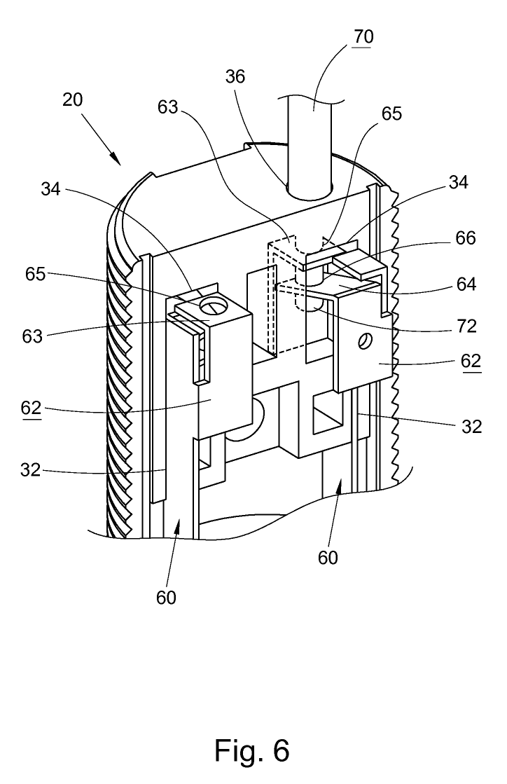

Referring to FIGS. 5 and 6, two electric wires 70 are fitted into the through holes 36 of the housing 20. The bare wire 72 of each the electric wire is inserted into the insertion holes 65, 66 of the insertion section 62 of each the conductive plate 60. When inserted, the bare wire 72 can be easily inserted into the insertion hole 66 of the oblique plate. However, when extracting the wire, the oblique plate 64 is pulled upward and becomes more inclined. Under such circumstance, the bare wire 72 is tightly bound by the wall of the insertion hole 66 so that the electric wire can not be pulled out. Accordingly, the electric wires can be fixed with the insertion sections 62.

The LED lamp 10 can be solely used. When it is necessary to increase the brightness and the illumination, the electric wires 70 with multiple LED lamps can be parallelly connected or serially connected. Accordingly, it is easy to connect multiple the LED lamps and the number of the connected LED lamps is not limited.

It should be noted that in practice, the two circuit boards can be integrated into one piece and the LED and the electronic elements are respectively soldered on a bottom face and a top face of the circuit board.

According to the above arrangement, the LED lamp is directly inbuilt with LED and can be directly used. Therefore, it is unnecessary to further install any LED bulb. The power consumption of such LED lamp is much lower than that of the traditional lamp employing conventional bulb.

The LED lamp of the present invention can be solely used. Alternatively, multiple LED lamps can be connected by means of connecting the electric wires to increase the brightness and the illumination.

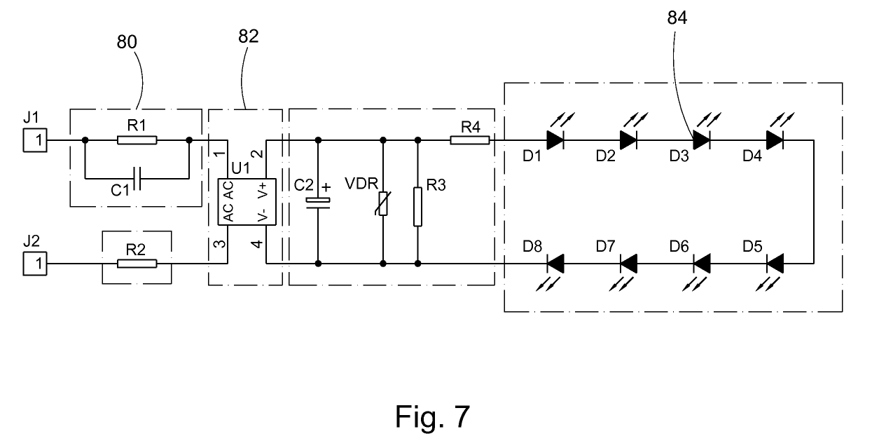

FIG. 7 shows a circuit device used in the present invention, which includes a pull-down circuit 80, a rectifier circuit 82 and several series-connected LED 84.

J1 and J2 are contacts. The pull-down circuit 80 comprises a resistor R1 and a capacitor C1. A resistor R2 offers a current-limiting effect and protects the circuit device from short circuit just like a fuse. The U1 of the rectifier circuit 82 is a bridge rectifier (rectifying diode). A capacitor C2 provides a filtering effect. A surge absorber VDR protects the LED 84 from impulse voltage.

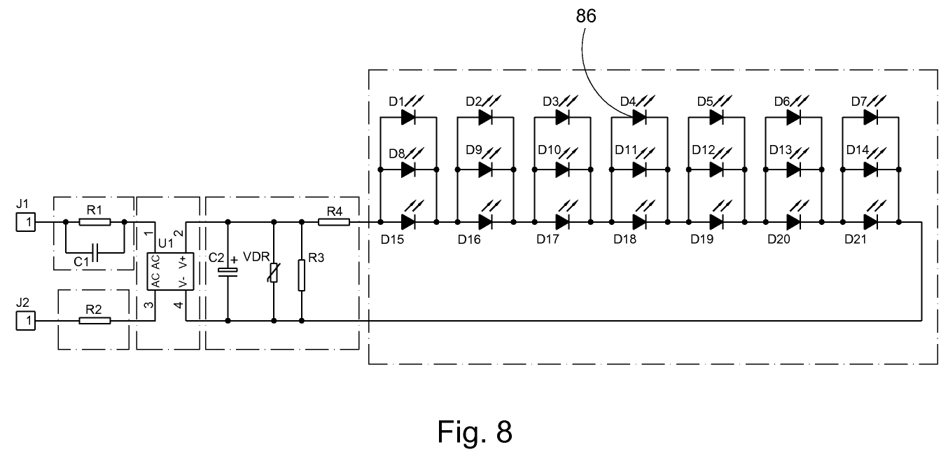

FIG. 8 shows another circuit device used in the present invention in which the LED 86 are series-parallel connected.

The above embodiments are only used to illustrate the present invention, not intended to limit the scope thereof. Many modifications of the above embodiments can be made without departing from the spirit of the present invention.

What is claimed is:

1. An LED lamp comprising:
a housing having a bottom end which is an open end, the housing being hollow, having a lower chamber and an upper chamber communicating with each other, the lower chamber being located at the bottom end of the housing, while the upper chamber being closer to a top end of the housing; at least one locating section being formed on inner wall face of the housing between the lower chamber and the upper chamber; two insertion slits being side by side formed in the housing, bottom ends of the insertion slits communicating with the upper chamber; two through holes being formed on a top end of the housing, inner ends of the through holes respectively communicating with the top ends of the insertion slits;
at least one circuit board;
several LED mounted on a bottom face of the circuit board and several electronic elements electrically connected with the circuit of the circuit board; the circuit board together with the LED and the electronic elements being installed in the housing, the circuit board being positioned in the locating section; the LED being located in the lower chamber, while the electronic elements being located in the upper chamber;
two conductive plates, a top end of each conductive plate having at least one insertion hole, the conductive plates being respectively installed in the two insertion slits, bottom ends of the conductive plates being electrically connected with the circuit board, the insertion holes of the conductive plates being respectively aligned with the through holes of the housing, whereby two electric wires can be respectively fitted through the through holes and inserted into the insertion holes of the conductive plates.

2. The LED lamp as claimed in claim 1, wherein two small spaces are formed in the housing above the two insertion slits, bottom ends of the small spaces respectively communicating with top ends of the two insertion slits, while top ends of the small spaces respectively communicating with the inner ends of the through holes; the top end of each conductive plate having an insertion section, the insertion sections of the conductive plates being respectively positioned in the small spaces; said at least one insertion hole being formed on the insertion section of each the conductive plate.

3. The LED lamp as claimed in claim 2, wherein each insertion section has a top face and an oblique plate located under the top face, the oblique plate being a cantilever and a free end of the oblique plate being swingable; a first insertion hole being formed on the top face of the insertion section, while a second insertion hole being formed on the oblique plate, the first and second insertion holes being aligned with each other.

4. The LED lamp as claimed in claim 1, wherein two contact pins are arranged on the top face of the circuit board; the bottom ends of the conductive plates being respectively connected with the contact pins.

5. The LED lamp as claimed in claim 1, wherein an upper locating section and a lower locating section are formed on inner wall face of the housing between the lower chamber and the upper chamber; a lower circuit board and an upper circuit board being horizontally parallelly arranged and electrically connected with each other, the lower circuit board being positioned in the lower locating section, while the upper circuit board being positioned in the upper locating section; the LED being mounted on a bottom face of the lower circuit board, while the electronic elements being mounted on a top face of the upper circuit board; the bottom ends of the conductive plates being electrically connected with the upper circuit board.

6. The LED lamp as claimed in claim 5, wherein the two circuit boards are separated from each other by an insulating board.

7. The LED lamp as claimed in claim 1, further comprising a lens mounted at a bottom end of the housing.

8. The LED lamp as claimed in claim 1, further comprising an optical collector which is a hollow conic body mounted in the lower chamber of the housing; the LED being arranged in the optical collector.

9. The LED lamp as claimed in claim 1, wherein an outer circumference of the housing is formed with a thread.

10. An LED lamp comprising:
a hollow housing having an open bottom end and an internal receiving space, a bottom end of the receiving space communicating with the open bottom end of the housing; at least one locating section being formed on inner wall face of the housing in the receiving space; two insertion slits being side by side formed in the housing, bottom ends of the insertion slits communicating with the receiving space; two through holes being formed on a top end of the housing, inner ends of the through holes respectively communicating with the top ends of the insertion slits;
at least one circuit board;
several LED mounted on a bottom face of the circuit board, the circuit board and the LED being installed in the receiving space, the circuit board being positioned in the locating section, the LED being located at a bottom end of the housing; and
two conductive plates respectively installed in the two insertion slits, bottom ends of the conductive plates being electrically connected with the circuit board, top ends of the conductive plates being respectively aligned with the through holes of the housing; whereby two electric wires can be respectively fitted through the through holes to contact with the top ends of the conductive plates.

11. The LED lamp as claimed in claim 10, wherein a top end of each conductive plate has at least one insertion hole; whereby two electric wires can be respectively inserted into the insertion holes of the conductive plates.

12. The LED lamp as claimed in claim 11, wherein two small spaces are formed in the housing above the two insertion slits, bottom ends of the small spaces respectively communicating with top ends of the two insertion slits, while top ends of the small spaces respectively communicating with the inner ends of the through holes; the top end of each conductive plate having an insertion section, the insertion sections of the conductive plates being respectively positioned in the small spaces; said at least one insertion hole being formed on the insertion section of each the conductive plate.

13. The LED lamp as claimed in claim 12, wherein each insertion section has a top face and an oblique plate located under the top face, the oblique plate being a cantilever and a free end of the oblique plate being swingable; a first insertion hole being formed on the top face of the insertion section, while a second insertion hole being formed on the oblique plate, the first and second insertion holes being aligned with each other.

14. The LED lamp as claimed in claim 10, further comprising several electronic elements electrically connected with the circuit board and located in the receiving space.

15. The LED lamp as claimed in claim 14, wherein an upper locating section and a lower locating section are formed on inner wall face of the housing; a lower circuit board and an upper circuit board being horizontally parallelly arranged and electrically connected with each other, the lower circuit board being positioned in the lower locating section, while the upper circuit board being positioned in the upper locating section; the LED being mounted on a bottom face of the lower circuit board; the electronic elements being connected with the upper circuit board; the bottom ends of the conductive plates being electrically connected with the upper circuit board.

16. The LED lamp as claimed in claim 15, wherein the two circuit boards are separated from each other by an insulating board.

17. The LED lamp as claimed in claim 10, further comprising a lens mounted at a bottom end of the housing.

18. The LED lamp as claimed in claim 10, further comprising an optical collector which is a hollow conic body mounted in the lower chamber of the housing; the LED being arranged in the optical collector.

19. The LED lamp as claimed in claim 10, wherein an outer circumference of the housing is formed with a thread.
